(19) United States
(12) Patent Application Publication
(10) Pub. No.: US 2015/0047331 A1
(43) Pub. Date: Feb. 19, 2015

(54) HYDRAULIC SYSTEM FOR MACHINE

(71) Applicant: Caterpillar Inc., Peoria, IL (US)

(72) Inventor: Darren A. Blum, Naperville, IL (US)

(73) Assignee: Caterpillar Inc., Peoria, IL (US)

(21) Appl. No.: 13/966,429

(22) Filed: Aug. 14, 2013

(51) Int. Cl. F15B 1/033

(52) U.S. Cl. CPC F15B 1/033
USPC 60/327; 60/413; 60/418

(57) ABSTRACT

A hydraulic system for a machine is disclosed. The system includes an actuator configured to move a portion of the machine, a pump configured to supply pressurized fluid to the actuator, an accumulator fluidly coupled to the actuator, a valve arrangement configured to selectively direct the fluid discharged from the actuator to the accumulator for storage and to selectively direct the stored fluid from the accumulator to the actuator, and a controller. The controller is configured to determine an accumulator pressure, an actuator pressure, and an operational parameter associated with an implement system. Further, the controller is configured to determine an accumulator control mode. The controller determines an accumulator pressure leakage rate when the accumulator control mode is neutral.

### TECHNICAL FIELD

The present disclosure relates generally to a hydraulic system and, more particularly, to a hydraulic system for a machine.

### BACKGROUND

Swing-type excavation machines, for example, but not limited to, hydraulic excavators and front shovels, require significant hydraulic pressure and flow to transfer material from a dig location to a dump location. These machines direct high-pressure fluid from an engine-driven pump through an actuator (E.g., a swing motor) to accelerate a loaded work tool at a start of each swing, and then restrict a flow of the fluid exiting the motor at the end of the swing to slow and stop the work tool.

In order to improve an efficiency of this type of hydraulic arrangement, one or more accumulators are provided in fluid communication the actuator. A valve arrangement provided between the actuator and the accumulators control charging or discharging of the accumulators with the fluid based on an operating state of the actuator. For example, when the actuator is in an acceleration mode, the accumulators are discharged, thereby providing assistance to the actuator. Conversely, when the actuator is in a deceleration mode, the accumulators are charged in order to store excess energy generated by the actuator.

During operation, one or more components of the valve arrangement may fail or develop defects. Consequently, the fluid may leak from the accumulators through the defective portion of the valve arrangement resulting in an excess drop in fluid pressure within the accumulators. This may reduce the efficiency of the hydraulic arrangement. Further, during operation of the machine, it may be difficult to detect any abnormal leakage. Consequently, it may be possible that the fault is undetected for a long duration resulting in a protracted inefficient operation of the machine.

For example, U.S. Pat. No. 5,221,125 discloses a fluid leakage preventing device incorporated in a hydraulically-operated system which includes an accumulator for storing a working fluid under pressure, an actuator operated by the fluid supplied from the accumulator, and a control valve having an open position and a closed position for fluid communication and disconnection between the accumulator and the actuator, respectively. The fluid leakage preventing device includes a fluid leakage detector for generating an output signal indicative of the leakage flow of the fluid from said accumulator through the control valve placed in the closed position. The device further includes a valve reciprocating arrangement responsive to the output signal of said fluid leakage detector, for effecting at least one reciprocating movement of a valving member of the control valve.

### SUMMARY

One aspect of the present disclosure is directed to a hydraulic system. The hydraulic system includes an actuator configured to move a portion of a machine, a pump configured to supply pressurized fluid to the actuator, an accumulator fluidly coupled to the actuator, a valve arrangement configured to selectively direct the fluid discharged from the actuator to the accumulator for storage and to selectively direct the stored fluid from the accumulator to the actuator, and a controller. The controller is configured to determine an accumulator pressure, an actuator pressure, and an operational parameter associated with an implement system. Further, the controller is configured to determine an accumulator control mode based on the actuator pressure, and the operational parameter of the implement system. Moreover, the controller is configured to determine an accumulator pressure leakage rate when the accumulator control mode is neutral.

Another aspect of the present disclosure is directed to a method of operating a hydraulic system. The method includes pressurizing fluid with a pump. The method further includes directing the pressurized fluid from the pump to a swing motor to move a portion of a machine. The method also includes directing, selectively, the fluid from the swing motor to an accumulator and from the accumulator back to the swing motor. Moreover, the method includes determining an accumulator pressure leakage rate. The method of determining the accumulator pressure leakage rate includes determining a first accumulator pressure at a first time instance after a first time interval, determining a second accumulator pressure at a second time instance subsequent to the first time instance during a second time interval, and determining the accumulator pressure leakage rate based on the first accumulator pressure, the second accumulator pressure, and the difference between the first and second time instances. Further, the accumulator pressure leakage rate is determined during a time period having a start subsequent to a start of the second time interval.

### BRIEF DESCRIPTION OF THE DRAWINGS

FIG. 1 is a diagrammatic illustration of an exemplary disclosed machine operating at a worksite with a haul vehicle;

FIG. 2 is a schematic illustration of an exemplary disclosed hydraulic system that may be used with the machine of FIG. 1.

FIG. 3 is an exemplary method of operating the hydraulic system;

FIG. 4 is an exemplary method of determining an accumulator leakage rate of the first accumulator; and

FIG. 5 is an exemplary schematic illustration of determining the accumulator leakage rate of the first accumulator.

### DETAILED DESCRIPTION

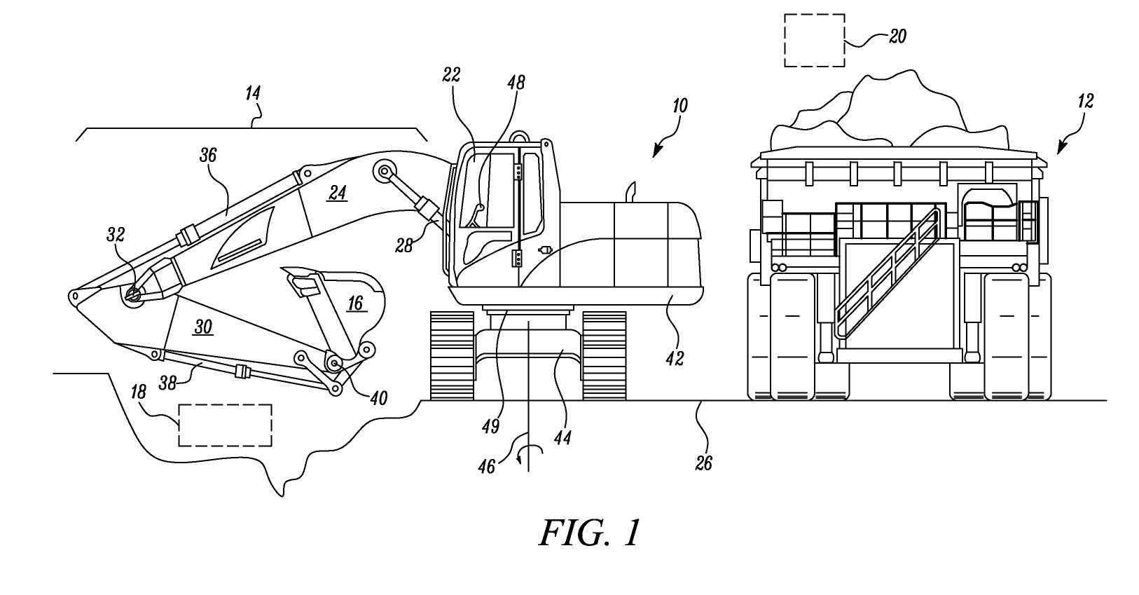

FIG. 1 illustrates an exemplary machine 10 having multiple systems and components that cooperate to excavate and load earthen material onto a nearby haul vehicle 12. In one example, the machine 10 may embody a hydraulic excavator. It is contemplated, however, that the machine 10 may embody another swing-type excavation or material handling machine such as a backhoe, a front shovel, a dragline excavator, or another similar machine. The machine 10 may include, among other things, an implement system 14 configured to move a work tool 16 between a dig location 18 within a trench or at a pile, and a dump location 20, for example, over the haul vehicle 12. The machine 10 may also include an operator station 22 for manual control of the implement system 14. It is contemplated that the machine 10 may perform operations other than truck loading, if desired, such as craning, trenching, and material handling.

The implement system 14 may include a linkage structure acted on by fluid actuators to move the work tool 16. Specifically, the implement system 14 may include a boom 24 that is vertically pivotal relative to a work surface 26 by a pair of adjacent, double-acting, hydraulic cylinders 28 (only one shown in FIG. 1). The implement system 14 may also include a stick 30 that is vertically pivotal about a horizontal pivot axis 32 relative to the boom 24 by a single, double-acting, hydraulic cylinder 36. The implement system 14 may further include a single, double-acting, hydraulic cylinder 38 that is operatively connected between the work tool 16 and the stick 30 and functional to tilt the work tool 16 vertically about a horizontal pivot axis 40. The boom 24 may be pivotally connected to a frame 42 of the machine 10, while the frame 42 may be pivotally connected to an undercarriage member 44 and swung about a vertical axis 46 by a swing motor 49. It is contemplated that any type of actuator, other than the swing motor 49, may be used for swinging the frame 42 about the vertical axis 46. For example, the hydraulic cylinders 28, actuating the boom 24, may be part of a boom hybrid system and are responsible for the swinging motion of the frame 42. The stick 30 may pivotally connect the work tool 16 to the boom 24 by way of the pivot axes 32 and 40. It is contemplated that a greater or lesser number of fluid actuators may be included within the implement system 14 and/or connected in a manner other than described above, if desired.

Numerous different work tools 16 may be attachable to the machine 10 and controllable via the operator station 22. The work tool 16 may include any device used to perform a particular task such as, for example, a bucket, a fork arrangement, a blade, a shovel, or any other task-performing device known in the art. Although connected in the embodiment of FIG. 1 to lift, swing, and tilt relative to the machine 10, the work tool 16 may alternatively or additionally rotate, slide, extend, or move in another manner known in the art.

The operator station 22 may be configured to receive input from a machine operator indicative of a desired work tool movement. Specifically, the operator station 22 may include one or more input devices 48 embodied, for example, as single or multi-axis joysticks, one or more levers, located proximal an operator seat (not shown). The input devices 48 may be proportional-type controllers configured to position and/or orient the work tool 16 by producing a work tool position signal that is indicative of a desired work tool speed and/or force in a particular direction. The position signal may be used to actuate any one or more of the hydraulic cylinders 28, 36, 38 and/or the swing motor 49. In an embodiment, one of the input devices 48 may include a swing lever that is configured to actuate the swing motor 49. It is contemplated that different input devices may alternatively or additionally be included within the operator station 22 such as, for example, wheels, knobs, push-pull devices, switches, pedals, and other operator input devices known in the art.

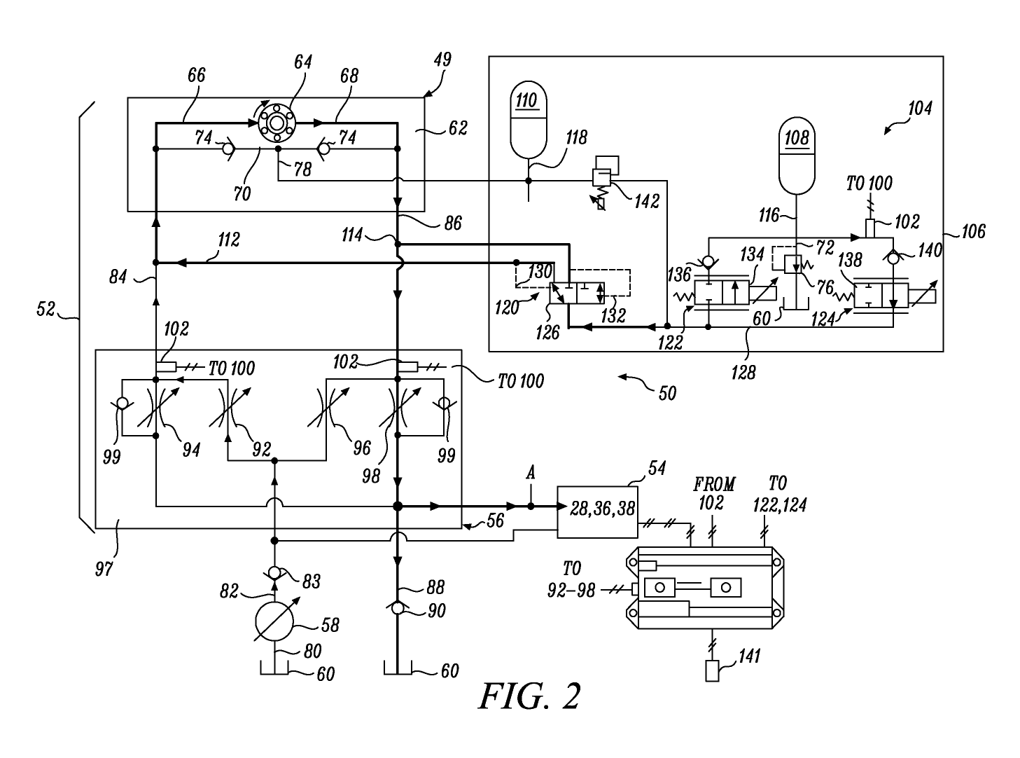

As illustrated in FIG. 2, the machine 10 may include a hydraulic system 50 having a plurality of fluid components that cooperate to move the implement system 14 (referring to FIG. 1). In particular, the hydraulic system 50 may include a first circuit 52 associated with the swing motor 49, and at least a second circuit 54 associated with the hydraulic cylinders 28, 36, and 38. The first circuit 52 may include, among other things, a swing control valve 56 connected to regulate a flow of pressurized fluid from a pump 58 to the swing motor 49 and from the swing motor 49 to a low-pressure tank 60 to cause a swinging movement of the work tool 16 about the vertical axis 46 (referring to FIG. 1) in accordance with an operator request received via the input device 48. The second circuit 54 may include similar control valves, for example a boom control valve (not shown), a stick control valve (not shown), a tool control valve (not shown), a travel control valve (not shown), and/or an auxiliary control valve connected in parallel to receive pressurized fluid from the pump 58 and to discharge waste fluid to the tank 60, thereby regulating the corresponding actuators (e.g., the hydraulic cylinders 28, 36, and 38).

The swing motor 49 may include a housing 62 at least partially forming a first and a second chamber (not shown) located to either side of an impeller 64. When the first chamber is connected to an output of the pump 58 (e.g., via a first chamber passage 66 formed within the housing 62) and the second chamber is connected to the tank 60 (e.g., via a second chamber passage 68 formed within the housing 62), the impeller 64 may be driven to rotate in a first direction (shown in FIG. 2). Conversely, when the first chamber is connected to the tank 60 via the first chamber passage 66 and the second chamber is connected to the pump 58 via the second chamber passage 68, the impeller 64 may be driven to rotate in an opposite direction (not shown). The flow rate of fluid through the impeller 64 may relate to a rotational speed of the swing motor 49, while a pressure differential across the impeller 64 may relate to an output torque thereof.

The swing motor 49 may include a built-in makeup functionality. In particular, a makeup passage 70 may be formed within the housing 62, between the first chamber passage 66 and the second chamber passage 68, and a pair of opposing check valves 74 may be disposed within the makeup passage 70. A low-pressure passage 78 may be connected to the makeup passage 70 at a location between the check valves 74. Based on a pressure differential between the low-pressure passage 78, and the first and second chamber passages 66, 68, one of the check valves 74 may open to allow fluid from the low-pressure passage 78 into the lower-pressure of one of the first and second chambers. A significant pressure differential may generally exist between the first and second chambers during a swinging movement of the implement system 14.

The pump 58 may be configured to draw fluid from the tank 60 via an inlet passage 80, pressurize the fluid to a desired level, and discharge the fluid to the first and second circuits 52, 54 via a discharge passage 82. A check valve 83 may be disposed within the discharge passage 82, if desired, to provide for a unidirectional flow of pressurized fluid from the pump 58 into the first and second circuits 52, 54. The pump 58 may embody, for example, a variable displacement pump (shown in FIG. 2), a fixed displacement pump, or another source known in the art. The pump 58 may be drivably connected to a power source (not shown) of the machine 10 by, for example, a countershaft (not shown), a belt (not shown), an electrical circuit (not shown), or in another suitable manner. Alternatively, the pump 58 may be indirectly connected to the power source of the machine 10 via a torque converter, a reduction gear box, an electrical circuit, or in any other suitable manner. The pump 58 may produce a stream of pressurized fluid having a pressure level and/or a flow rate determined, at least in part, by demands of the actuators within the first and second circuits 52, 54 that correspond with operator requested movements. The discharge passage 82 may be connected within the first circuit 52 to the first and second chamber passages 66, 68 via the swing control valve 56, and the first and second chamber conduits 84, 86, respectively, which extend between the swing control valve 56 and the swing motor 49.

The tank 60 may constitute a reservoir configured to hold a low-pressure supply of fluid. The fluid may include, for example, a dedicated hydraulic oil, an engine lubrication oil, a transmission lubrication oil, or any other fluid known in the art. One or more hydraulic systems within the machine 10 may draw fluid from and return fluid to the tank 60. It is contemplated that the hydraulic system 50 may be connected to multiple separate fluid tanks or to a single tank, as desired. The tank 60 may be fluidly connected to the swing control valve 56 via a drain passage 88, and to the first and second chamber passages 66, 68 via the swing control valve 56 and the first and second chamber conduits 84, 86, respectively. The tank 60 may also be connected to the low-pressure passage 78 (see connection points “A”). A check valve 90 may be disposed within the drain passage 88, if desired, to promote a unidirectional flow of fluid into the tank 60.

The swing control valve 56 may have elements that are movable to control the rotation of the swing motor 49 and corresponding swinging motion of the implement system 14. Specifically, the swing control valve 56 may include a first chamber supply element 92, a first chamber drain element 94, a second chamber supply element 96, and a second chamber drain element 98 all disposed within a common block or housing 97. The first and second chamber supply elements 92, 96 may be connected in parallel with the discharge passage 82 to regulate filling of their respective chambers with fluid from the pump 58, while the first and second chamber drain elements 94, 98 may be connected in parallel with the drain passage 88 to regulate draining of the respective chambers of fluid. A makeup valve 99, for example a check valve, may be disposed between an outlet of the first chamber drain element 94 and the first chamber conduit 84, and between an outlet of the second chamber drain element 98 and the second chamber conduit 86.

To drive the swing motor 49 to rotate in the first direction (shown in FIG. 2), the first chamber supply element 92 may be shifted to allow pressurized fluid from the pump 58 to enter the first chamber of the swing motor 49 via the discharge passage 82 and the first chamber conduit 84, while the second chamber drain element 98 may be shifted to allow fluid from the second chamber of the swing motor 49 to drain to the tank 60 via the second chamber conduit 86 and the drain passage 88. To the drive swing motor 49 to rotate in the opposite direction, the second chamber supply element 96 may be shifted to communicate the second chamber of the swing motor 49 with pressurized fluid from the pump 58, while the first chamber drain element 94 may be shifted to allow draining of fluid from the first chamber of the swing motor 49 to the tank 60. It is contemplated that both the supply and drain functions of the swing control valve 56 (i.e., of the four different supply and drain elements) may alternatively be performed by a single valve element associated with the first chamber and a single valve element associated with the second chamber, or by a single valve element associated with both the first and second chambers, if desired.

The supply and drain elements 92-98 of the swing control valve 56 may be solenoid-movable against a spring bias in response to a flow rate command issued by a controller 100. In particular, the swing motor 49 may rotate at a velocity that corresponds with the flow rate of fluid into and out of the first and second chambers. Accordingly, to achieve an operator-desired swing velocity, a command based on an assumed or measured pressure may be sent to the solenoids (not shown) of the supply and drain elements 92-98 that causes them to open an amount corresponding to the necessary flow rate through the swing motor 49. This command may be in the form of a flow rate command or a valve element position command that is issued by the controller 100.

The controller 100 may be in communication with the different components of the hydraulic system 50 to regulate operations of the machine 10. For example, the controller 100 may be in communication with the elements of the swing control valve 56 in the first circuit 52 and with the elements of control valves (not shown) associated with the second circuit 54. Based on various operator input and monitored parameters, as will be described in more detail below, the controller 100 may be configured to selectively activate the different control valves in a coordinated manner to efficiently carry out operator requested movements of the implement system 14.

The controller 100 may include a memory, a secondary storage device, a clock, and one or more processors that cooperate to accomplish a task consistent with the present disclosure. Numerous commercially available microprocessors can be configured to perform the functions of the controller 100. It should be appreciated that the controller 100 could readily embody a general machine controller capable of controlling numerous other functions of the machine 10. Various known circuits may be associated with the controller 100, including signal-conditioning circuitry, communication circuitry, and other appropriate circuitry. It should also be appreciated that the controller 100 may include one or more of an application-specific integrated circuit (ASIC), a field-programmable gate array (FPGA), a computer system, and a logic circuit configured to allow the controller 100 to function in accordance with the present disclosure.

The operational parameters monitored by the controller 100, in one embodiment, may include a pressure of fluid within the first and/or second circuits 52, 54. For example, one or more pressure sensors 102 may be strategically located in fluid communication with the first chamber and/or second chamber conduits 84, 86 to sense a pressure of the respective passages and generate a corresponding signal indicative of the pressure directed to the controller 100. In an embodiment, the pressure sensors 102 may provide a signal indicative of the pressure differential across the swing motor 49 to the controller 100. It is contemplated that any number of the pressure sensors 102 may be placed in any location within the first and/or second circuits 52, 54, as desired. It is further contemplated that other operational parameters such as, for example, speeds, temperatures, viscosities, densities, etc. may also or alternatively be monitored and used to regulate operation of the hydraulic system 50, if desired.

The hydraulic system 50 may be fitted with an energy recovery arrangement (ERA) 104 that is in communication with at least the first circuit 52 and is configured to selectively extract and recover energy from waste fluid that is discharged from the swing motor 49. The ERA 104 may include, among other things, a recovery valve block (RVB) 106 that is fluidly connectable between the pump 58 and the swing motor 49, a first accumulator 108 configured to selectively communicate with the swing motor 49 via the RVB 106, and a second accumulator 110 also configured to selectively communicate with the swing motor 49. The RVB 106 may therefore act as a valve arrangement within the hydraulic system 50. In the disclosed embodiment, the RVB 106 may be fixedly and mechanically connectable to one or both of the swing control valve 56 and the swing motor 49, for example directly to the housing 62 and/or directly to the housing 97. The RVB 106 may include an internal first passage 112 fluidly connectable to the first chamber conduit 84, and an internal second passage 114 fluidly connectable to the second chamber conduit 86. The first accumulator 108 may be fluidly connected to the RVB 106 via a conduit 116, while the second accumulator 110 may be fluidly connectable to the low-pressure passage 78 via a conduit 118.

The RVB 106 may house a selector valve 120, a charge valve 122 associated with the first accumulator 108, a discharge valve 124 associated with the first accumulator 108 and disposed in parallel with the charge valve 122, and a relief valve 76. The selector valve 120 may selectively fluidly communicate one of the first and second passages 112, 114 with the charge and discharge valves 122, 124 based on a pressure of the first and second passages 112, 114. The charge and discharge valves 122, 124 may be movable in response to commands from the controller 100 to selectively fluidly communicate the first accumulator 108 with the selector valve 120 for fluid charging and discharging purposes. The relief valve 76 may selectively connect an outlet of the first accumulator 108 and/or a downstream side of the charge valve 122 with the tank 60 to relieve pressures of the hydraulic system 50.

The selector valve 120 may be a pilot-operated, 2-position, 3-way valve that is movable in response to fluid pressure in the first and second passages 112, 114 (i.e., in response to a fluid pressure within the first and second chambers of the swing motor 49). In particular, the selector valve 120 may include a valve element 126 that is movable from a first position (shown in FIG. 2) at which the first passage 112 is fluidly connected to the charge and discharge valves 122, 124 via an internal passage 128, toward a second position (not shown) at which the second passage 114 is fluid connected to the charge and discharge valves 122, 124 via passage 128. The passage 128 may also be connected to the second accumulator 110 and the makeup valves 74 via the low-pressure passage 78 (i.e., the low-pressure passage 78 may terminate at the passage 128). When the first passage 112 is fluidly connected to the charge and discharge valves 122, 124 via the passage 128, fluid flow through the second passage 114 may be inhibited by the selector valve 120 and vice versa. The first and second pilot passages 130, 132 may communicate fluid from the first and second passages 112, 114, respectively, to opposing ends of the valve element 126 such that a higher-pressure one of the first or second passages 112, 114 may cause the valve element 126 to move and fluidly connect the corresponding passage with the charge and discharge valves 122, 124 via passage 128.

The charge valve 122 may be a solenoid-operated, variable position, 2-way valve that is movable in response to a command from the controller 100 to allow fluid from the passage 128 to enter the first accumulator 108. In particular, the charge valve 122 may include a valve element 134 that is movable from a first position (shown in FIG. 2) at which fluid flow from the passage 128 into the first accumulator 108 is inhibited, toward a second position (not shown) at which the passage 128 is fluidly connected to the first accumulator 108. When the valve element 134 is away from the first position (i.e., in the second position or in another position between the first and second positions) and a fluid pressure within the passage 128 exceeds a fluid pressure within the first accumulator 108, fluid from the passage 128 may fill (i.e., charge) the first accumulator 108. The valve element 134 may be spring-biased toward the first position and movable in response to a command from the controller 100 to any position between the first and second positions to thereby vary a flow rate of fluid from the passage 128 into the first accumulator 108. A check valve 136 may be disposed between the charge valve 122 and the first accumulator 108 to provide for a unidirectional flow of fluid into the first accumulator 108 via the charge valve 122.

The discharge valve 124 may be substantially identical to the charge valve 122 in composition, and movable in response to a command from the controller 100 to allow fluid from the first accumulator 108 to enter the passage 128 (i.e., to discharge). In particular, the discharge valve 124 may include a valve element 138 that is movable from a first position (not shown) at which fluid flow from the first accumulator 108 into the passage 128 is inhibited, toward a second position (shown in FIG. 2) at which the first accumulator 108 is fluidly connected to the passage 128. When the valve element 138 is away from the first position (i.e., in the second position or in another position between the first and second positions) and a fluid pressure within the first accumulator 108 exceeds a fluid pressure within the passage 128, fluid from the first accumulator 108 may flow into the passage 128. The valve element 138 may be spring-biased toward the first position and movable in response to a command from the controller 100 to any position between the first and second positions to thereby vary a flow rate of fluid from the first accumulator 108 into the passage 128. A check valve 140 may be disposed between the first accumulator 108 and the discharge valve 124 to provide for a unidirectional flow of fluid from the first accumulator 108 into the passage 128 via the discharge valve 124.

The relief valve 76 may be disposed within a relief passage 72 that is in fluid communication with an outlet of the charge valve 122, an inlet of the discharge valve 124, and the first accumulator 108. Based on a pressure of the first accumulator 108 (or a pressure of the fluid passing through the charge valve 122 and/or entering the discharge valve 124), the relief valve 76 may open to allow the high-pressure fluid to spill into the tank 60. It is contemplated that a manual valve (not shown) may be associated with the relief valve 76 (e.g., disposed within a bypass passage connected at inlet and outlet ends of the relief valve 76) may be provided, if desired, to facilitate manual draining of the first accumulator 108.

In some embodiments, an additional valve 142 may be disposed between the passage 128 and the makeup passage 70 (e.g., within the low-pressure passage 78), to help regulate the flow of makeup fluid to the makeup valves 74. In particular, the valve 142 may be movable from a first position at which flow from the passage 128 to the low-pressure passage 78 is blocked, toward a second position at which flow is allowed to pass between the two passages. The valve 142 may be movable from the first position toward the second position based on a pressure within the passage 128 (e.g., when a pressure within the passage 128 exceeds a threshold pressure of the valve 142). When the valve 142 is in the first position, makeup fluid may only be provided to the makeup passage 70 from the second accumulator 110. However, when the valve 142 is in the second position, makeup fluid may be provided from both the second accumulator 110 and from the passage 128 (i.e., from the first accumulator 108 via the passage 128). In addition, it may be possible for the second accumulator 110 to be charged with fluid from the passage 128 (i.e., charged with fluid from the first accumulator 108), via the valve 142. It is contemplated that the pressure at which the valve 142 moves from the first position to the second position may be variable, if desired, as is shown in FIG. 2.

An additional pressure sensor 102 may be associated with the first accumulator 108 and configured to generate signals indicative of a pressure of fluid within the first accumulator 108, if desired. In the disclosed embodiment, the additional pressure sensor 102 may be disposed between the first accumulator 108 and the discharge valve 124. The additional pressure sensor 102 therefore acts as an accumulator pressure sensor. It is contemplated, however, that the additional pressure sensor 102 may alternatively be disposed between the first accumulator 108 and the charge valve 122 or directly connected to the first accumulator 108, if desired. Signals from the additional pressure sensor 102 may be directed to the controller 100 for use in regulating operation of the charge and/or discharge valves 122, 124.

The first and second accumulators 108, 110 may each embody pressure vessels filled with a compressible gas that are configured to store pressurized fluid for future use by the swing motor 49. The compressible gas may include, for example, nitrogen, argon, helium, or another appropriate compressible gas. As fluid in communication with the first and second accumulators 108, 110 exceeds predetermined pressures of the first and second accumulators 108, 110, the fluid may flow into the first and second accumulators 108, 110. Because the gas therein is compressible, it may act like a spring and compress as the fluid flows into the first and second accumulators 108, 110. When the pressure of the fluid within the conduits 116, 118 drops below the predetermined pressures of the first and second accumulators 108, 110, the compressed gas may expand and urge the fluid from within the first and second accumulators 108, 110 to exit. It is contemplated that the first and second accumulators 108, 110 may alternatively embody membrane/spring-biased or bladder types of accumulators, if desired.

In the disclosed embodiment, the first accumulator 108 may be a larger (e.g., about 5-20 times larger) and higher-pressure (e.g., about 5-60 times higher-pressure) accumulator, as compared to the second accumulator 110. Specifically, the first accumulator 108 may be configured to accumulate up to about 50-100 L of fluid having a pressure in the range of about 260-315 bar, while the second accumulator 110 may be configured to accumulate up to about 10 L of fluid having a pressure in the range of about 5-30 bar. In this configuration, the first accumulator 108 may be used primarily to assist the motion of the swing motor 49 and to improve machine efficiencies, while second accumulator may be used primarily as a makeup accumulator to help reduce a likelihood of voiding at the swing motor 49. It is contemplated, however, that other volumes and pressures may be accommodated by the first and/or second accumulators 108, 110, if desired.

The controller 100 may be configured to selectively cause the first accumulator 108 to charge and discharge, thereby improving performance of the machine 10. In particular, a typical swinging motion of the implement system 14 instituted by the swing motor 49 may consist of segments of time during which the swing motor 49 is accelerating a swinging movement of the implement system 14 and segments of time during which the swing motor 49 is decelerating the swinging movement of the implement system 14. The acceleration segments may require significant energy from the swing motor 49 that is conventionally realized by way of pressurized fluid supplied to the swing motor 49 by the pump 58, while the deceleration segments may produce significant energy in the form of pressurized fluid that is conventionally wasted through discharge to the tank 60. Both the acceleration and deceleration segments may require the swing motor 49 to convert significant amounts of hydraulic energy to kinetic energy, and vice versa. After pressurized fluid passes through the swing motor 49, however, it still contains a large amount of energy. If the fluid passing through the swing motor 49 is selectively collected within the first accumulator 108 during the deceleration segments, this energy can then be returned to (i.e., discharged) and reused by the swing motor 49 during the ensuing acceleration segments. The swing motor 49 can be assisted during the acceleration segments by selectively causing the first accumulator 108 to discharge pressurized fluid into the higher-pressure chamber of the swing motor 49 (via the discharge valve 124, the passage 128, the selector valve 120, and the appropriate one of the first and second chamber conduits 84, 86), alone or together with high-pressure fluid from the pump 58, thereby propelling the swing motor 49 at the same or greater acceleration and velocity with less pump power than otherwise possible via the pump 58 alone. The swing motor 49 can be assisted during the deceleration segments by selectively causing the first accumulator 108 to charge with fluid exiting the swing motor 49, thereby providing additional resistance to the motion of the swing motor 49 and lowering a restriction and cooling requirement of the fluid exiting the swing motor 49.

In an alternative embodiment, the controller 100 may be configured to selectively control charging of the first accumulator 108 with fluid exiting the pump 58, as opposed to fluid exiting the swing motor 49. That is, during a peak-shaving or economy mode of operation, the controller 100 may be configured to cause the accumulator 108 to charge with fluid exiting the pump 58 (e.g., via the swing control valve 56, the appropriate one of the first and second chamber conduits 84, 86, the selector valve 120, the passage 128, and the charge valve 122) when the pump 58 has excess capacity (i.e., a capacity greater than required by the swing motor 49 to complete a current swing of the work tool 16 requested by the operator). Then, during times when the pump 58 has insufficient capacity to adequately power the swing motor 49, the high-pressure fluid previously collected from the pump 58 within the first accumulator 108 may be discharged in the manner described above to assist the swing motor 49.

The controller 100 may be configured to regulate the charging and discharging of the first accumulator 108 based on a current or ongoing segment of the excavation work cycle of the machine 10. In particular, based on input received from one or more performance sensors 141, the controller 100 may be configured to partition a typical work cycle performed by the machine 10 into a plurality of segments, for example, into a dig segment, a swing-to-dump acceleration segment, a swing-to-dump deceleration segment, a dump segment, a swing-to-dig acceleration segment, and a swing-to-dig deceleration segment. Based on the segment of the excavation work cycle currently being performed, the controller 100 may selectively cause the first accumulator 108 to charge or discharge, thereby assisting the swing motor 49 during the acceleration and deceleration segments.

One or more maps relating signals from performance sensor(s) 141 and the pressure sensors 102 to the different segments of the excavation work cycle may be stored within the memory of the controller 100. Each of these maps may include a collection of data in the form of tables, graphs, and/or equations. In one example, threshold speeds, velocities, swing motor pressure, accumulator pressures, cylinder pressures, and/or operator input (e.g., lever position) associated with the start and/or end of one or more of the segments may be stored within the maps. In another example, threshold forces and/or actuator positions associated with the start and/or end of one or more of the segments may be stored within the maps.

In an embodiment, the stored data may include a threshold pressure value DeltaP_Min which is the minimum pressure differential (between the first chamber and second chamber conduits 84, 86) across the swing motor 49 required for acceleration or deceleration segments of a work cycle of the machine 10. The pressure differential may be positive or negative based on the direction of rotation of the swing motor 49 resulting in clockwise or counter-clockwise swinging motion of the machine 10. The acceleration or deceleration segments may include a swing-to-dump acceleration segment, a swing-to-dig acceleration segment, a swing-to-dump deceleration segment, a swing-to-dig deceleration segment, or the like.

Further, the stored data may include a threshold operator input value Lever_Min which is the minimum degree of actuation of the swing lever (one of the operator input devices 48) required to actuate the swing motor 49. The degree of actuation of the swing lever may vary from −100% (full actuation in negative direction) to 100% (full actuation in positive direction). The positive or negative actuation of the swing lever may correspond to different directions of swing motion of the machine 10, for example, clockwise or counter-clockwise, respectively.

Further, the stored data may include a threshold velocity value Vel_Min which is the minimum swing velocity of the machine 10 (i.e., the swing velocity of the frame 42 relative to the undercarriage member 44) during deceleration segments of a work cycle of the machine 10. The deceleration segments may include a swing-to-dump deceleration segment, a swing-to-dig deceleration segment, or the like. The swing velocity may be positive or negative depending on the direction of swinging motion of the machine 10. Further, the swing velocity of the machine 10 may lie within a range from about −10 RPM to 10 RPM.

The controller 100 may be configured to reference the signals from performance sensor(s) 141 and the pressure sensors 102 with the maps stored in memory to determine the segment of the excavation work cycle currently being executed, and then regulate the charging and discharging of first accumulator 108 accordingly. The controller 100 may also provide alerts to the operator of the machine 100 based on the determination of any fault within a part of the machine 10. The controller 100 may allow the operator of the machine 10 to directly modify these maps and/or to select specific maps from available relationship maps stored in the memory of the controller 100 to affect segment partitioning and accumulator control, as desired. It is contemplated that the maps may additionally or alternatively be automatically selectable based on modes of machine operation, if desired.

The performance sensor(s) 141 may be associated with one or more operational parameters of the implement system 14. For example, the performance sensor(s) 141 may be associated with the generally horizontal swinging motion of the implement system 14 including the work tool 16 imparted by the swing motor 49 (i.e., the motion of frame 42 relative to the undercarriage member 44). In an embodiment, the performance sensor(s) 141 may embody a rotational position or speed sensor associated with an angular position or speed associated with the pivot connection between the frame 42 and the undercarriage member 44 (shown in FIG. 1). The signal generated by performance sensor(s) 141 may be sent to and recorded by controller 100 during each excavation work cycle. It is contemplated that controller 100 may derive a swing velocity of the frame 42 relative to the undercarriage member 44 based on a position or a speed signal from performance sensor(s) 141 and an elapsed period of time, if desired.

Additionally, the performance sensor(s) 141 may be associated with the actuation of the operator input devices 48. Specifically, the performance sensor(s) 141 may be a displacement sensor associated with movement or position of the operator input devices 48, or any other type of sensor known in the art that may generate a signal indicative of an actuation of the operator input devices 48. In an embodiment, the performance sensor(s) 141 may generate a signal indicative of a degree of actuation of the swing lever that is used actuate the swing motor 49, resulting in a generally horizontal swinging motion of the work tool 16. It is contemplated that the controller 100 may derive a position of the swing lever based on a position signal from the performance sensor(s) 141.

In an embodiment, the controller 100 may determine an accumulator control mode based on the various parameters, such as, the pressure differential across the swing motor 49, the swing lever actuation state, and the swing velocity. The accumulator control mode may be related to a mode of the first accumulator 108, and include an acceleration mode, a deceleration mode, and/or a neutral mode. In the acceleration mode, the first accumulator 108 may assist the swing motor 49 by providing fluid via the discharge valve 124, while in the deceleration mode, the first accumulator 108 may store fluid via the charge valve 122. In the neutral mode, the swing motor 49 is neither accelerating nor decelerating, and the first accumulator 108 is neither charging or discharging and, therefore isolated from the internal passage 128 by the charge and discharge valves 122, 124.

In case the controller 100 detects that the accumulator control mode is neutral, the controller 100 determines a pressure within the first accumulator 108 after a predetermined time interval. The controller 100 then checks whether the accumulator pressure lies within a predetermined range. The predetermined range of the accumulator pressure may correspond to a charged state of the first accumulator 108 wherein the first accumulator 108 stores sufficient fluid to assist the swing motor 49. Subsequently, the controller 100 determines an accumulator pressure leakage rate for a predefined time period. The accumulator pressure leakage rate is the rate of reduction of pressure inside the first accumulator 108 due to leakage of fluid from the first accumulator 108, usually through the one or more valves associated with the accumulator. The controller 100 then compares the accumulator pressure leakage rate with a predetermined threshold and triggers an accumulator fault condition if the accumulator leakage rate is greater than the predetermined threshold leakage rate. In an exemplary embodiment, the predetermined threshold leakage rate is about 60 kPa/sec. The accumulator fault condition may be indicated to the operator of the machine 10 in the form of a visual feedback, an audio feedback, a tactile feedback, or a combination thereof. In an embodiment, a display device (not shown) may be provided in the operator station 22. An audio device (not shown), such as a speaker, may also be provided in the operator station 22. The accumulator fault condition may be indicated to the operator by the display device and/or the audio device. Further, a tactile feedback may be provided via the operator input device 48, for example, a joystick. In an embodiment, the controller 100 may include an output module that is connected to the display device, audio device, and/or the operator input device 48. In an alternate embodiment, the controller 100 may include a wireless module to transmit the accumulator fault condition wirelessly to the display device, audio device, and/or the operator input device 48. Thus, the controller 100 can be configured to trigger an accumulator fault condition during an operation of the machine 10 when both the swing motor 49 and the pump 58 are running. The details of the determination of the accumulator control mode and the accumulator pressure leakage rate are described hereinafter in more detail.

### INDUSTRIAL APPLICABILITY

The disclosed hydraulic system may be applicable to any excavation machine that performs a substantially repetitive work cycle, which involves swinging movements of a work tool. The excavation machine may be a hydraulic excavator, a backhoe, a front shovel, a dragline excavator, or another similar machine. The disclosed hydraulic system includes an actuator in the form of the swing motor. It is also applicable to other type of hydraulic actuator systems such as a cylinder boom implement system where instead of swing motor actuator, the actuator is a hydraulic piston-rod cylinder. In this instance, other machines include lifting mechanisms such as wheel loaders, hoists in trucks, or blade systems for track-type tractors. The accumulator pressure leakage rate determination method described herein can be correlated with the leakability of the valve arrangement associated with the accumulator. Depending on the desirable conditions of the system, the pressure rate thresholds and time intervals can be modified. Further, an accumulator fault condition can be triggered when the accumulator leakage rate is greater than the predetermined threshold leakage rate. The accumulator fault condition can indicate to the operator that the accumulator is not working as efficiently as possible and/or that the valve arrangement associated with the accumulator is leaking in an undesirable manner. Thus, the fault can be detected relatively more quickly, and with the appropriate diagnostics and servicing of the valve arrangement and/or the accumulator it is associated therewith, the machine can be restored to operate more efficiently. In addition, the method can be operated, regardless of the operation of the pump and/or actuator. In other words, the machine, and in this instance the swing operation, is operable, while the accumulator pressure leakage rate determination method is running.

Referring to FIGS. 1 and 2, the hydraulic system 50 for the machine 10 includes the swing motor 49 responsible for the swinging motion of the implement system 14 of the machine 10 (shown in FIG. 1). The pump 58 is configured to selectively supply pressurized fluid to the swing motor 49. The hydraulic system 50 includes the energy recovery arrangement (ERA) 104 to selectively extract and recover energy from waste fluid that is discharged from the swing motor 49. The ERA 104 includes the recovery valve block (RVB) 106 that is fluidly connectable between the pump 58 and the swing motor 49, the first accumulator 108 configured to selectively communicate with the swing motor 49 via the RVB 106, and the second accumulator 110 also configured to selectively communicate with the swing motor 49. The RVB 106 includes the selector valve 120, the charge valve 122 associated with the first accumulator 108, the discharge valve 124 associated with the first accumulator 108 and disposed in parallel with the charge valve 122, and the relief valve 76. The charge and discharge valves 122, 124 may be movable in response to commands from the controller 100 to selectively fluidly communicate the first accumulator 108 with the selector valve 120 for fluid charging and discharging purposes.

When the accumulator control mode is neutral, i.e., the first accumulator 108 is neither charging nor discharging, and both the charge and discharge valves 122, 124 are closed, there may be an abnormal drop in fluid pressure within the first accumulator 108 due to excessive leakage of fluid across at least one of the charge valve 122, the discharge valve 124 and the relief valve 76. The excessive leakage may be due one or more reasons, for example, improper setting and/or failure of the relief valve 76, any fault and/or failure of the charge or discharge valves 122, 124 etc. The excessive leakage may reduce the efficiency of the ERA 104 and may be difficult to detect during operation of the machine 10. Thus, it may be possible that the fault is undetected for a long duration resulting in a protracted inefficient operation of the machine 10.

According to the present disclosure, the controller 100 monitors the accumulator pressure leakage rate when the accumulator control mode is neutral during an operation of the machine 10. In case the accumulator pressure leakage rate is greater than the predetermined threshold leakage rate, the controller 100 can be configured to trigger an accumulator fault condition. The accumulator fault condition can alert the operator of the machine 10 about any fault in the ERA 104 so that timely action may be taken to rectify the fault(s). Thus, the hydraulic system 50, according to the present disclosure, can enable detection of any fault(s) causing excessive leakage from the first accumulator 108 during operation of the machine 10 when the pump 58 and the swing motor 49 are running. In an embodiment, the accumulator fault condition may be indicated to the operator of the machine 10 in the form of a visual feedback, an audio feedback, a tactile feedback, or a combination thereof. For example, the accumulator fault condition may be indicated to the operator via the display device, the audio device and/or the operator input device 48 in the operator station 22. Further, the accumulator fault condition may be transmitted wirelessly to the display device, audio device, and/or the operator input device 48. In an embodiment, the hydraulic system 50 can be also configured to enable detection of any fault(s) causing excessive leakage from the first accumulator 108 during operation of the machine 10 when the pump 58 and the swing motor 49 are running or when they are not running.

In an embodiment, the operator, on receiving the accumulator fault condition, may stop one or more operations of the machine 10, and then investigate any fault(s) that may cause excessive leakage from the first accumulator 108. In another embodiment, the controller 100 may automatically run a fault diagnosis program after triggering the accumulator fault condition, and may transmit a diagnostic message to the operator indicating any location(s) and/or defective component(s) that are causing the excessive leakage. The diagnostic message may also be transmitted wirelessly to a remotely located server. The server may be accessible to service and maintenance personnel who may then inspect the machine 10. In a further embodiment, the controller 100 may automatically stop one or more operations of the machine 10 after triggering the accumulator fault condition.

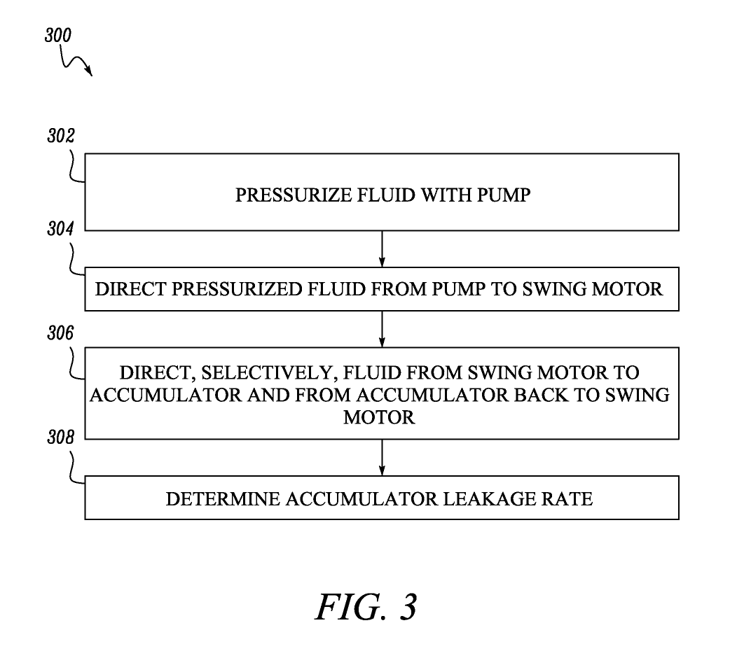

FIG. 3 illustrates a method 300 of operating the hydraulic system 50, according to an embodiment of the present disclosure. At step 302, the method 300 includes drawing fluid from the tank 60 and pressurizing fluid with the pump 58. At step 304, the method 300 further includes directing pressurized fluid from the pump 58 to the swing motor 49 (the actuator of the hydraulic system) in order to move the implement system 14 of the machine 10. The movement may be the generally horizontal swinging motion of the frame 42 including the implement system 14 relative to the undercarriage member 44. At step 306, fluid from the swing motor 49 may be selectively directed to the first accumulator 108 and from the first accumulator 108 to the swing motor 49. In other examples, fluid may be sourced from another hydraulic function, a pump, or other non-actuator sources. Likewise, in other examples, the fluid stored in the first accumulator 108 may be provided to another hydraulic function, a motor, or other non-actuators. The RVB 106 including the selector valve 120, the charge valve 122 and the discharge valve 124 may control flow of fluid between the swing motor 49 and the first accumulator 108 as described above. Further, the relief valve 76 may control flow of fluid between the first accumulator 108 and the tank 60. At step 308, the accumulator pressure leakage rate is determined. In an embodiment, the control mode associated with the first accumulator 108 may be determined before determining the accumulator pressure leakage rate. The determined accumulator pressure leakage rate is then compared with a predetermined threshold and an accumulator fault condition is triggered if the accumulator leakage rate is greater than the predetermined threshold leakage rate. Methods for step 308 will be described hereinafter in more detail.

delete

Various parameters may have to be determined for determining the control mode and the accumulator pressure leakage rate associated with the accumulator 108. The parameters may include a swing motor pressure, an accumulator pressure, and an operational parameter associated with the implement system 14. A swing motor pressure may be determined by measuring a pressure differential (DeltaP) across the swing motor 49. The pressure sensors 102 located in fluid communication with the first chamber and/or second chamber conduits 84, 86 generate a signal indicative of the pressure differential (DeltaP) across the swing motor 49 to the controller 100. Further, one or more operational parameters associated with the implement system 14 may be determined. The operational parameter may include a swing velocity (Swing_Vel) of the frame 42, including the implement system 14, relative to the undercarriage member 44. The performance sensor(s) 141 may generate a signal which may be sent to and recorded by the controller 100 during each excavation work cycle. The controller 100 may derive a swing velocity based on the signal from the performance sensor(s) 141. Additionally, the operational parameter may include a degree of actuation of the swing lever (Swing_Lev) that is used actuate the swing motor 49, resulting in a generally horizontal swinging motion of the work tool 16. The performance sensor(s) 141 may be a displacement sensor associated with movement or position of the swing lever. The controller 100 may derive a position of the swing lever based on a position signal from the performance sensor(s) 141. The accumulator pressure within the first accumulator 108 may be determined based on signals generated by the additional pressure sensor 102. Signals from the additional pressure sensor 102 may be directed to the controller 100 in order to determine the accumulator pressure.

The accumulator control mode associated with the first accumulator 108 may be determined based on pressure differential (DeltaP) across the swing motor 49, the degree of actuation of the swing lever (Swing_Lev), and the swing velocity (Swing_Vel) associated with the implement system 14. DeltaP may be compared with the threshold pressure value DeltaP_Min which is the minimum pressure differential across the swing motor 49 required for acceleration or deceleration segments of a work cycle of the machine 10. Further, Swing_Lev may be compared with Lever_Min which is the minimum degree of actuation of the swing lever required to actuate the swing motor 49. Moreover, Swing_Vel may be compared with Vel_Min which is the minimum swing velocity of the machine 10 during deceleration segments of a work cycle of the machine 10.

Based on the above comparisons, the accumulator control mode associated with the first accumulator 108 may be determined. In an embodiment, if the absolute values of DeltaP, Swing_Lev and Swing_Vel are greater than DeltaP_Min, Lever_Min and Vel_Min, respectively, the swing motor 49 may be accelerating either in a positive or negative direction, and the first accumulator 108 is discharging. In a further embodiment, if the absolute values of DeltaP and Swing_Lev are greater than DeltaP_Min and Lever_Min, respectively, and the signs of DeltaP and Swing_Lev are different (i.e. DeltaP is positive and Swing_Lev is negative, or vice versa), the swing motor 49 may be decelerating either in a positive or negative direction, and the first accumulator 108 is charging. Moreover, in another embodiment, if the absolute values of DeltaP and Swing_Vel are greater than DeltaP_Min and Vel_Min, respectively, and the signs of DeltaP and Swing_Vel are different (i.e. DeltaP is positive and Swing_Vel is negative, or vice versa), the swing motor 49 may be decelerating either in a positive or negative direction. If all the above conditions for accelerating and decelerating modes of the swing motor 49 are not satisfied, then the accumulator control mode is neutral, i.e., the first accumulator 108 is neither charging nor discharging, and the charge and discharge valves 122, 124 are closed. The accumulator pressure leakage rate may be determined when the accumulator control mode is neutral as the first accumulator 108 is isolated. Therefore, the accumulator pressure leakage rate may be determined accurately. The various steps for determining the accumulator control mode, as described above, are purely exemplary in nature and the accumulator control mode may be determined in any alternate manner without deviating from the scope of the disclosure.

delete

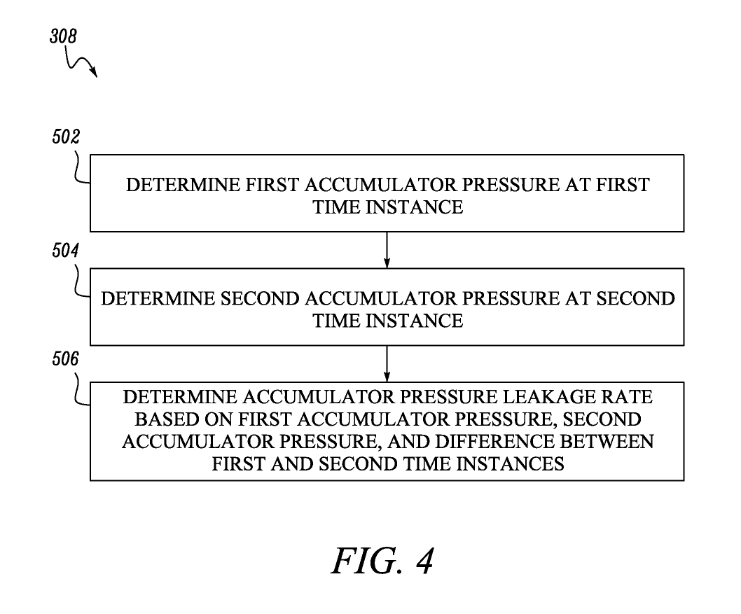

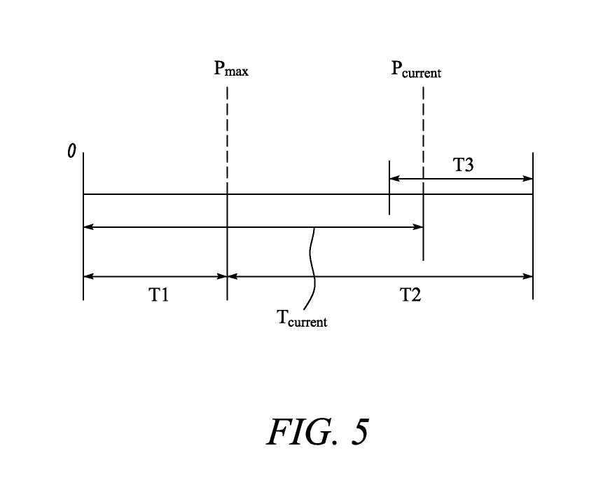

FIG. 4 illustrates details of step 308, of the method 300, for determining an accumulator pressure leakage rate of the first accumulator 108, according to an embodiment of the present disclosure. FIG. 5 illustrates a schematic illustration of a timeline of step 308, according to an embodiment of the present disclosure. In an embodiment, the accumulator pressure leakage rate may be determined only when the accumulator control mode is neutral. The controller 100 is configured to determine the accumulator control mode. Further, when the accumulator control mode is neutral, the controller 100 is configured to determine whether the accumulator pressure lies within a predefined range of pressure. The accumulator pressure may lie within the predefined range in a charged state of the first accumulator 108. For example, the accumulator pressure may lie within a range from about 26 MPa to 32 MPa in a charged state. In an embodiment, the accumulator pressure leakage rate may be determined only when the accumulator pressure lies within the predefined range and the accumulator control mode is neutral. Thus, the accumulator pressure leakage rate may be calculated when first accumulator 108 is in a transition state from charging to discharging. At step 502, when the accumulator control mode is neutral and the accumulator pressure is within the predefined range, the controller 100 is configured to receive a signal indicative of a first accumulator pressure (Pmax) at a first time instance after a first predetermined time interval T1 from initiation of the sequence, as shown in FIG. 5. In an embodiment, T1 may be about 0.3 seconds. T1 is provided in order for the pressure signal to stabilize and avoid temporary pressure spikes during pressure readings. At step 504, the controller 100 is configured to determine the a second accumulator pressure (Pcurrent) at a second time instance (Tcurrent) subsequent to the first time instance during a second time interval T2 that starts after T1 and runs until end of the sequence, as shown in FIG. 5. In an embodiment, T2 may be about 1.7 seconds. At step 506, the controller 100 is configured to determine the accumulator pressure leakage rate based on the first accumulator pressure (Pmax), the second accumulator pressure (Pcurrent), and the difference between the first (T1) and second (Tcurrent) time instances. The accumulator leakage rate at Tcurrent is therefore calculated as (Pmax-Pcurrent)/(Tcurrent-T1). The controller 100 is then configured to compare the determined accumulator leakage rate with a predetermined threshold leakage rate. In an exemplary embodiment, the predetermined threshold leakage rate may be about 60 kPa/sec. The controller 100 is configured to trigger an accumulator fault condition when the determined accumulator leakage rate is above the predetermined threshold leakage rate at an instance (or predetermined number of instances) during a time period T3, which is at least not during the initial segment of the time period T2 (shown as the last segment of T2 in FIG. 5). In other words, there is a time lag between the start of the time period T3 and the time period T2, and the end of the time period T3 and the time period T2 may be shared. In an embodiment, T3 may be the last 0.7 seconds of T2. The accumulator leakage rate may be calculated multiple times within the time period T3 and multiple fault conditions may be triggered. The controller 100 may trigger the one or more fault conditions. In some examples, the controller 100 is configured to trigger an accumulator fault condition when the accumulator leakage rate is maintained above the predetermined threshold leakage rate during the time period T3, instead of a single or few instances. The accumulator leakage rate, as calculated by in step 308, may be less susceptible to sensor noise as compared with using derivative block.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents

What is claimed is:

1. A hydraulic system comprising:
an actuator configured to move a portion of a machine;
a pump configured to supply pressurized fluid to the actuator;
an accumulator fluidly coupled to the actuator;
a valve arrangement configured to selectively direct the fluid discharged from the actuator to the accumulator for storage and to selectively direct the stored fluid from the accumulator to the actuator; and
a controller configured to:
determine an accumulator control mode based on an accumulator pressure, an actuator pressure, and an operational parameter of the implement system; and
determine an accumulator pressure leakage rate when the accumulator control mode is neutral.

2. The hydraulic system of claim 1, wherein the controller is further configured to:
compare the accumulator pressure leakage rate with a predetermined threshold leakage rate; and
trigger an accumulator fault condition when the accumulator pressure leakage rate is greater than the predetermined threshold leakage rate.

3. The hydraulic system of claim 1, wherein the controller is configured to:
receive the accumulator pressure after a predetermined time interval when the accumulator control mode is neutral; and
determine the accumulator leakage rate after the predetermined time interval and for a predefined time period.

4. The hydraulic system of claim 3, wherein the controller is configured to determine the accumulator leakage rate after the predetermined time interval if the pressure associated with the accumulator is within a predefined pressure range.

5. The hydraulic system of claim 1, wherein the controller is configured to determine the accumulator pressure leakage rate while the pump and the actuator are in operation.

6. The hydraulic system of claim 1, wherein the operational parameter associated with the implement system comprises a swing velocity.

7. The hydraulic system of claim 1, wherein the operational parameter associated with the implement system comprises a degree of actuation of a swing lever.

8. The hydraulic system of claim 1, wherein the actuator pressure is a pressure differential across the actuator.

9. The hydraulic system of claim 1, wherein the actuator is a swing motor.

10. The hydraulic system of claim 1, wherein the valve arrangement comprises:
a selector valve configured to selectively connect a higher pressure of one of the first and second chamber passages with the accumulator; and
a single pressure relief valve disposed within the accumulator circuit and configured to relieve pressure of the hydraulic system.

11. The hydraulic system of claim 10, wherein the valve arrangement further comprises:
a charge valve fluidly connected between the selector valve and the accumulator; and
a discharge valve fluidly connected between the selector valve and the accumulator in parallel with the charge valve;
wherein the single pressure relief valve is fluidly connected with each of the accumulator, the charge valve, the discharge valve, and the tank.

12. A hydraulic system comprising:
a swing motor configured to move a portion of a machine;
a pump configured to supply pressurized fluid to the swing motor;
an accumulator fluidly coupled to the swing motor;
an accumulator pressure sensor associated with the accumulator;
a valve arrangement configured to selectively direct the fluid discharged from the swing motor to the accumulator for storage and to selectively direct the stored fluid from the accumulator to the swing motor; and
a controller communicably coupled with the accumulator pressure sensor, the controller configured to:
determine a first accumulator pressure (Pmax) at a first time instance after a first time interval (T1);
determine a second accumulator pressure (Pcurrent) at a second time instance subsequent to the first time instance during a second time interval (T2);
determine an accumulator pressure leakage rate based on the first accumulator pressure (Pmax), the second accumulator pressure (Pcurrent), and the difference between the first and second time instances, wherein the accumulator pressure leakage rate is determined during a time period (T3) having a start subsequent to a start of the second time interval (T2).

13. The hydraulic system of claim 12, wherein the controller is configured to compare the determined accumulator pressure leakage rate to a predefined accumulator pressure leakage rate, and to trigger an accumulator fault condition when the determined accumulator pressure leakage rate is greater than the predetermined threshold leakage rate.

14. The hydraulic system of claim 13, wherein the controller is configured to determine an accumulator control mode based on an accumulator pressure, a swing motor pressure, and an operational parameter of the implement system, and wherein the controller is further configured to determine the accumulator pressure leakage rate when the accumulator control mode is neutral.

15. A method of operating a hydraulic system, the method comprising:
pressurizing a fluid with a pump;
directing the pressurized fluid from the pump to a swing motor to move a portion of a machine; and
directing, selectively, the fluid from the swing motor to an accumulator and from the accumulator back to the swing motor;
determining an accumulator pressure leakage rate, wherein determining the accumulator pressure leakage rate comprises:
determining a first accumulator pressure (Pmax) at a first time instance after a first time interval (T1);
determining a second accumulator pressure (Pcurrent) at a second time instance subsequent to the first time instance during a second time interval (T2); and
determining an accumulator pressure leakage rate based on the first accumulator pressure (Pmax), the second accumulator pressure (Pcurrent), and the difference between the first and second time instances, wherein the accumulator pressure leakage rate is determined during a time period (T3) having a start subsequent to a start of the second time interval (T2).

16. The method of claim 15 further comprising:
comparing the determined accumulator pressure leakage rate with a predetermined threshold leakage rate; and
triggering an accumulator fault condition if the determined accumulator pressure leakage rate is greater than the predetermined threshold leakage rate.

17. The method of claim 16, wherein determining an accumulator control mode based on an accumulator pressure, a swing motor pressure, and an operational parameter of the implement system, and wherein determining the accumulator pressure leakage rate when the accumulator control mode is neutral.

18. The method of claim 17, wherein determining the accumulator pressure leakage rate when the accumulator pressure is within a predefined pressure range.

19. The method of claim 15, wherein determining the accumulator pressure leakage rate while the pump and the swing motor are in operation.

20. The method of claim 15, wherein:
the accumulator is a first accumulator; and
the method further comprises directing the pressurized fluid from the swing motor to a second accumulator and from the second accumulator to the swing motor.
